(19) United States
(12) Patent Application Publication
(10) Pub. No.: US 2013/0266783 A1
(43) Pub. Date: Oct. 10, 2013

(54) METHOD FOR PRODUCING MOLDINGS HAVING DIFFERENT SURFACE MATERIALS

(71) Applicant: Dominik Stadler, Oberschneidig (DE)

(72) Inventor: Dominik Stadler, Oberschneidig (DE)

(73) Assignee: WALLERSTEIN INTERIOR GMBH, Wallerstein (DE)

(21) Appl. No.: 13/993,409

(22) PCT Filed: Aug. 23, 2011
(86) PCT No.: PCT/EP2011/064478

§ 371 Date: Jun. 12, 2013

(30) Foreign Application Priority Data
Dec. 29, 2010 (DE) 10 2010 056 347.1
Mar. 18, 2011 (DE) 10 2011 014 513.3

(51) Int. Cl. B32B 38/00

(52) U.S. Cl. CPC B32B 38/0012
USPC 428/213; 156/222

(57) ABSTRACT

The invention relates to a method for producing moldings, comprising the method steps of laminating an upper material layer onto a carrier layer to generate a first layer composite, placing an upper layer on the first layer composite to generate a second layer composite, wherein the upper layer is substantially as thick as the first layer composite, and forming the second layer composite into a predetermined target shape.

The invention relates to a method for producing molded parts, in particular decorative parts for any type of vehicles and aircraft, by means of which different surface materials can be presented and brought into the desired final shape.

To date, a plurality of surface materials may be used and realized on the visible side of molded decorative parts. However, the different materials each require correspondingly adapted production methods. In the example described below, this will be explained by means of molded parts of aluminum and molded parts comprising a wood veneer.

Molded parts of aluminum are conventionally produced in a plurality of method steps. Initially, the starting material is punched out of an aluminum sheet. Next, the forming into the desired target shape is accomplished by a plurality of forming steps. Usually, a pressing tool is used, which produces the essential shape of the molded part with a number of strokes and brings the molded part into the final shape by means of a final stroke forming it to size.

Molded parts provided with a wood veneer on the visible side require a completely different production method, in which the forming and pressing of the component part take place in one method operation. For such molded parts comprising a wood veneer, a wooden face veneer on a dry glue layer is placed onto the lower veneer (blind veneer) which, again, is placed with a dry glue layer onto a second lower veneer being arranged perpendicular to the first lower veneer. In this case, the fiber directions of the two lower veneers run towards each other substantially at right angles (locking structure) so as to obtain a predefined stability of the component part. This assembly is placed into a pressing tool and, for 4 to 5 minutes, brought into the target shape by means of the action of heat, with the dry glues between the veneers melting and connecting the previously loosely joined layers. The pressing operation is carried out at approximately 140° C. so as to reactivate the thermosetting dry glues. The pressing period of 4 to 5 minutes is necessary to allow the thermosetting dry glue to be cross-linked and anchored (cohesion and adhesion) with the respectively adjacent layers. After completion of the component part same is removed from the wood component part press, and a fixing structure is back-injected behind it in an injection mold, which ultimately serves as fixing device for mounting the part in the vehicle or aircraft.

Alternative production methods for molded parts comprising wood veneers are the so-called membrane pressing or hot pressing. In both methods, a layer of wood veneer, backed with fleece, is laid onto the previously produced fixing structure, which substantially has the target shape towards the visible side, and is pressed by means of membrane pressing or hot pressing into the target shape that corresponds to the carrier structure. To allow the wood veneer to adapt its shape to the various contours of the final component part it has to be provided with notches punched or lasered into its edge region in advance, which allow an adaptation when the wood veneer is laid onto the upper side of the carrier structure. This is problematical however, as the notches come open as the wood veneer is pulled across the contours, i.e. clearances occur, which have to be luted in a complicated manner afterwards. In the finished component part the luted notches represent the regions with the greatest risk of cracking, which would lead to the uselessness of the part.

### OBJECT OF THE INVENTION

Based on the method for producing molded parts of aluminum and molded parts comprising a wood veneer as known from the prior art it is the object of the invention to provide an improved method for producing molded parts having optional surface materials, wherein the production time per molded part is reduced and the necessity for notches in the edge region of the surface material is avoided.

This object is achieved by a method for producing molded parts according to claim 1. A production method of this type comprises the steps of laminating an upper material layer onto a carrier layer so as to produce a first layer composite, laying an upper layer onto the first layer composite so as to produce a second layer composite, wherein the upper layer substantially has the thickness of the first layer composite, and forming the second layer composite into a predetermined target shape.

The upper material layer may be a wood veneer layer, a textile layer, a fabric layer, a carbon layer, a leather layer or a film layer.

The method step of forming the second layer composite into a predetermined target shape is a press-forming without the action of heat, which corresponds to a pressing method for molded parts of aluminum. If a wood veneer layer is used as the upper material layer same is formed to size and conditioned before laying the upper layer onto the first layer composite, that is, ground to the desired thickness and moistened, e.g. vaporized, during the forming to increase the flexibility.

In a preferred embodiment the carrier layer is formed as an aluminum layer, as the forming processes for molded parts of aluminum can here advantageously also be applied to the method according to the invention. The aluminum layer has a thickness of 0.3 to 0.6 mm, preferably 0.4 mm. Moreover, a coupling layer is laminated onto the upper and/or lower side of this carrier layer so as to improve the coupling of the subsequent layers. The coupling layer may be a film, such as a polyester or polyamide film.

It is particularly advantageous in the method according to the invention that by laying an upper layer onto the first layer composite, wherein the upper layer substantially has the thickness of the first layer composite, the upper material layer is brought into the so-called neutral phase for the forming process of the second layer composite, i.e. substantially into the middle of the second layer composite. In the prior art strong tensile forces occur in the outer region during the forming process, while correspondingly strong shear forces and compressions occur in the opposite inner region, and the drawing in the region of the outer bends could result in cracks in the upper material layer and affect the appearance. By the use of the upper layer, and by the thus obtained transfer of the upper material layer into the neutral phase, these tensile forces and compressive forces in the region of the material to be formed are reduced to a minimum. It is sufficient that the upper layer substantially has the thickness of the first layer composite, wherein the tensile forces and compressive forces are at a minimum if the upper side (visible side) of the upper material layer represents the middle of the second layer composite.

The inventive arrangement of upper layer, upper material layer and carrier layer allows the forming of sensitive upper material layers like wood veneer, leather, carbon and the like, without the action of heat, and at a rate that is at least 4 to 5 times as fast as the hot or membrane pressing.

In an advantageous embodiment of the present invention the upper layer is formed as an aluminum layer and has a thickness which corresponds to the thickness of the molded aluminum part. Thus, two molded parts can be produced simultaneously in one method operation, one being a molded part of aluminum and the other one being a molded part with a corresponding upper material layer, e.g. a molded part comprising a wood veneer.

For the further treatment it is possible to separate the upper material layer and thus the first layer composite, respectively, and the upper aluminum layer after the forming of the second layer composite. In order to separate the upper material layer enclosed within the aluminum layer after the forming it may be provided in an advantageous embodiment that at least one tab is provided at an empirically determined position of the upper material layer and/or the aluminum layer. The two parts are particularly easy to separate if one tab is provided on each of them.

In a preferred embodiment the thickness of the aluminum layer is 0.6 to 0.8 mm, preferably 0.6 mm, and can thus form an independent molded aluminum part.

Regardless of whether one molded part or two molded parts is/are produced by the method according to the invention, a fixing structure is subsequently back-injected behind the molded parts by means of injection molding. This fixing structure serves as a fixing device later, to connect the molded part in the vehicle or aircraft. In using the method according to the invention it is particularly advantageous that the molded part comprising the upper material and the molded aluminum part can be used in the same back-injection mold. Both molded parts substantially have the same outer shape and can be inserted into and fixed in one and the same injection mold. Hence, it is not necessary to provide a plurality of injection molds for molded parts of aluminum or molded parts with other surface materials, such as leather, carbon, wood etc.

In the method according to the invention it is another advantage that the molded part comprising the upper material is formed to be deliberately smaller after the forming process than the molded aluminum part, or any formed upper layer, lying on the visible side of the upper material. As the molded part comprising the upper material is arranged on the lower side (opposite to the visible side) of the molded aluminum part it has an outer dimension which is reduced by the size or thickness of the upper layer or molded aluminum part, respectively. To compensate this offset two options are possible. Either the molded part comprising the upper material, which is too small, is inserted into the injection mold and substantially brought or expanded to the desired target shape by means of injection molding pressure. Alternatively, an additional forming step could be performed after the separation of the molded part comprising the upper material from the upper layer or molded aluminum part, respectively, in which the molded part comprising the upper material is pressed with a prefabricated blank into the desired outer contour from below. It is noted, however, that the offset is so small, namely maximally 0.8 mm, that from a practical point of view no adaptation has to be made. Nevertheless, this offset may be used in a specific embodiment of the invention. To this end, the molded part comprising the upper material is provided with a lacquer coat on the visible side, so that the molded part comprising the upper material receives the outer dimension of the molded aluminum part. The fixing structure is then correspondingly smaller.

According to an advantageous embodiment for producing the molded part with a lacquer coat it is possible to integrally injection-mold a sealing edge at the same time of back-injecting the fixing structure, which serves as a seal from the coating tool used for the subsequent lacquer coating. The sealing edge merely serves as an auxiliary means during the lacquer coating process, and is milled off later to finish the component part.

Thus, the method according to the invention allows the production of three different component parts, all of which have the same outer contour and can be fixed alternatively at the same position in the respective vehicle. On the one hand, a molded part comprising the upper material can be produced, with an upper material of wood veneer, leather, fabric, textile, carbon or a film. Alternatively, this molded part comprising the upper material may be coated with lacquer. Finally, a molded aluminum part can be provided at the same time.

Further advantages of the invention will be explained in more detail below by means of the figures, together with the description of preferred embodiments. In the drawings:

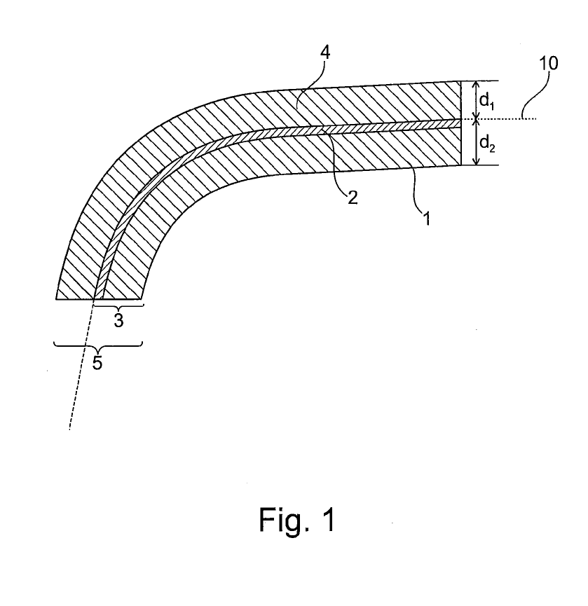

FIG. 1 shows a sectional side view of a formed second layer composite;

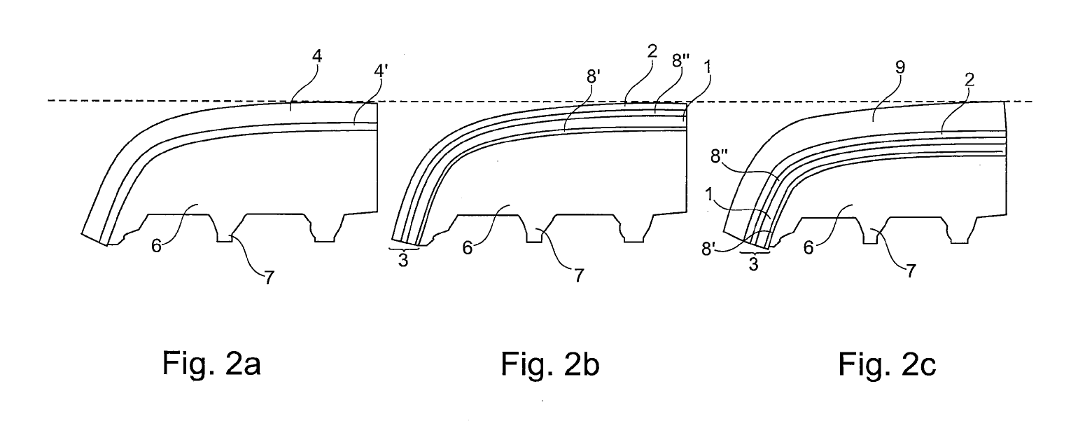

FIG. 2a shows a sectional side view of a molded aluminum part;

FIG. 2b shows a sectional side view of a molded part comprising the upper material;

FIG. 2c shows a sectional side view of a molded part comprising the upper material with a lacquer coat on the upper side;

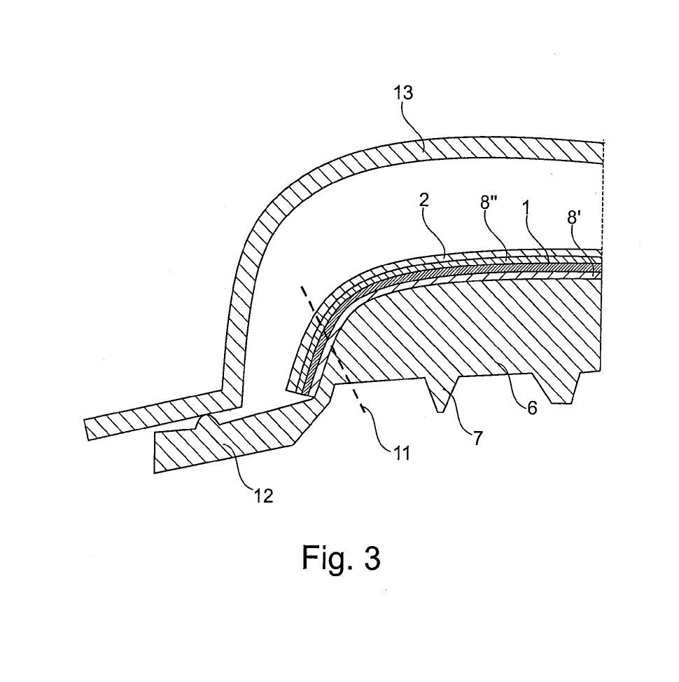

FIG. 3 shows a sectional side view of a component part with an integrally injection-molded sealing edge.

The illustration of the accompanying figures is a schematic example. In the figures, like components are designated with like reference numbers, Moreover, only those elements are shown that are important for the understanding of the invention.

FIG. 1 shows a sectional side view of an arrangement in which two molded parts lying on each other are simultaneously formed by the production method according to the invention. An upper material layer 2 is laminated onto a carrier layer 1, so that a first layer composite 3 is formed. An upper layer 4 is laid onto this first layer composite 3, so that a second layer composite 5 is formed which is pressed in its entirety into a predetermined target shape. In the embodiment shown, the forming is merely a bending by approximately 90°. However, any desired realizable shapes may be obtained with pressing tools. Both the upper layer 4 and the carrier layer 1 are made of aluminum and, therefore, can be formed in an aluminum forming tool for molded parts of aluminum. In the method according to the invention the component parts substantially have the same thickness. In the embodiment shown, the thickness d1 of the upper layer 4 corresponds to thickness d2 of the first layer composite 3. After the forming of the second layer composite 5 the first layer composite 3 is separated from the upper aluminum layer 4, thereby forming a molded part comprising the upper material and a molded aluminum part. Thus, two molded parts of different materials can be produced at a high speed in one method operation.

The upper layer 4 is detachably placed onto the first layer composite 3. For the separation both the upper layer 4 and the carrier layer 1 are provided with tabs (not shown) at which the respective component parts can be grabbed and separated. In the embodiment shown in FIG. 1, the upper material layer 2 is a wood veneer layer which was formed to size and conditioned before being laid onto the carrier layer 1. Alternatively, the upper material may also be leather, carbon, textile, fabric or a film. By the arrangement of the upper material layer, which is sensitive relative to the other layers, between the carrier layer 1 and the upper layer 4, the upper material layer 2 is located in the neutral phase 10 during the forming process, where the impact of shear and compressive forces is smallest. The upper layer 4 of aluminum has a thin protective lacquer surface on the outer side (on the visible side) which protects the aluminum component part from external impacts such as scratching. As the upper aluminum layer 4 becomes an independent molded aluminum part it is already provided with the correspondingly predetermined thickness for the forming.

FIGS. 2a to 2c show sectional side views of three molded parts with different surfaces. In FIG. 2a, a fixing structure 6 is back-injected behind the upper aluminum layer 4 of FIG. 1 by means of injection molding, with journals 7 being integrally injection-molded, which serve to lock the molded part into place in the vehicle. The upper aluminum layer 4 includes a coupling layer 4′ on the side facing away from the visible side, which has been omitted in FIG. 1 for the sake of clarity. The coupling layer 4′ serves to better couple and adhere the fixing structure 6 to the upper aluminum layer 4.

In FIG. 2b, a fixing structure 6 is back-injected behind the first layer composite 3 of FIG. 1. By adapting the injection pressure an expansion of the component part is achieved so that, ultimately, a molded part is obtained the outer dimension of which is identical with that of the molded aluminum part of FIG. 2a. A film coupling layer 8′ is provided between the fixing structure 6 and the carrier layer 1, a second coupling layer 8″ is provided between the carrier structure 1 and the upper material layer, both having been omitted in FIG. 1 for the sake of clarity. Basically, films may be used as coupling layers which are laminated in advance onto the respective material. Thus, it is possible, for instance, that such a coupling layer be laminated onto the aluminum carrier layer and the upper material layer prior to the forming process and before the layers are placed onto each other. The back-injection process for the molded aluminum part of FIG. 2a and the molded part with the upper material layer 2 is carried out in one and the same injection mold. The upper material layer of wood veneer 2 forms the surface on the visible side and is merely coated with a thin protective layer, e.g. a very thin lacquer coat, with the surface remaining open-pored.

FIG. 2c shows another use of the first layer composite 3 already illustrated in FIG. 2b in a sectional side view. In this case, the smaller outer dimension (offset) of the first layer composite 3, which is obtained in the simultaneous forming process according to FIG. 1, is used to provide a third surface variation, wherein the ultimately obtained molded part, again, has the same outer dimension. In FIGS. 2a to 2c this is demonstrated by the dashed line at the end edge of the visible side. The molded part comprising the upper material formed of the first layer composite 3 and the fixing structure 6 is provided with a lacquer coat 9 which has a predetermined thickness to compensate the offset. The lacquer coat 9 is produced by means of a common lacquer coating method. In order to compensate the larger thickness of the lacquer coat 9 and the first layer composite 3 a correspondingly smaller fixing structure 6 is back-injected.

From the two component parts having aluminum and wood veneer on the visible side, which were obtained in the forming process of FIG. 1, thus two molded parts according to FIG. 2a and 2b, or 2c can ultimately be obtained.

FIG. 3 shows the first layer composite 3, formed of an upper material layer 2 and a carrier layer 1, with coupling layers 8′ and 8″ arranged on both sides, in a state placed in a lacquer coating plant, the component part being surrounded by a coating bell 13. A special fixing structure 6 is back-injected behind the molded part comprising the upper material, with an integrally injection-molded sealing edge 12 serving as a seal from the coating bell 13 during the lacquer coating process. The sealing edge 12 extends beyond the molded part comprising the upper material in a lateral direction, and bears against the coating bell 13. Subsequently, lacquer is poured onto the upper material 2, while the sealing edge 12 prevents the lacquer from escaping. Once the lacquer coat 9 is solidified, the molded part comprising the upper material is brought to the desired size along the milling edge 11. The sealing edge 12 is milled off at the same time.

The implementation of the invention is not limited to the above-described preferred embodiments. Rather, a plurality of variations are conceivable, using the solution described also in different implementations. For instance, any layer suited for the pressing process may be used instead of the upper aluminum layer, as long as this layer substantially has the thickness of the first layer composite and the upper material layer is thus transferred into the neutral phase for the forming process.

1. Method for producing molded parts, comprising the steps of:
a. laminating an upper material layer onto a carrier layer so as to produce a first layer composite,
b. laying an upper layer onto the first layer composite so as to produce a second layer composite, wherein the upper layer substantially has the thickness of the first layer composite,
c. forming the second layer composite into a predetermined target shape.

2. Method according to claim 1, characterized in that the upper layer and/or the carrier layer is/are made of aluminum.

3. Method according to claim 2, characterized in that after the forming of the second layer composite the upper material layer and the first layer composite are separable and form a molded part comprising the upper material and a molded aluminum part.

4. Method according to claim 3, characterized in that a fixing structure is back-injected behind the molded part comprising the upper material and/or the molded aluminum part by means of injection molding.

5. Method according to claim 4, characterized in that the molded part comprising the upper material and the molded aluminum part are usable in the same back-injection mold.

6. Method according to claim 5, characterized in that the molded part comprising the upper material is enlarged to the outer dimension of the molded aluminum part during the injection molding.

7. (canceled)

8. Method according to claim 4, characterized in that the molded part comprising the upper material is provided with a lacquer coat, so that the molded part comprising the upper material receives the outer dimension of the molded aluminum part.

9. Method according to claim 2, characterized in that the upper aluminum layer has a thickness which corresponds to the thickness of the molded aluminum part.

10. Method according to claim 2, characterized in that the upper material layer and/or the upper aluminum layer is/are provided with at least one tab.

11. Method according to claim 1, characterized in that the carrier layer is provided with a coupling layer on the upper and/or lower side.

12. Method according to claim 1, characterized in that the upper aluminum layer comprises a protective lacquer surface.

13. Method according to claim 1, characterized in that the upper material layer is a wood veneer layer, a leather layer, a carbon layer, a textile layer, a fabric layer or a film layer.

14. Method according to claim 13, characterized in that the wood veneer layer is formed to size and conditioned before laying on the upper aluminum layer.

15. Method according to claim 1, characterized in that the forming corresponds to a pressing process for molded aluminum parts.

16. Vehicle comprising a molded part produced according to a method as claimed in claim 1.

17. Method for producing molded parts, comprising the steps of:
a. laminating an upper material layer onto a carrier layer so as to produce a first layer composite,
b. laying an upper layer onto the first layer composite so as to produce a second layer composite, wherein the upper layer substantially has the thickness of the first layer composite,
c. forming the second layer composite into a predetermined target shape,
wherein a fixing structure is back-injected behind the molded part comprising the upper material and/or the molded aluminum part by means of injection molding,
wherein the molded part comprising the upper material is enlarged to the outer dimension of the molded aluminum part during the injection molding.

18. Method according to claim 17, characterized in that the molded part comprising the upper material is provided with a lacquer coat, so that the molded part comprising the upper material receives the outer dimension of the molded aluminum part.

19. Method for producing molded parts, comprising the steps of:
a. laminating an upper material layer onto a carrier layer so as to produce a first layer composite,
b. laying an upper layer onto the first layer composite so as to produce a second layer composite, wherein the upper layer substantially has the thickness of the first layer composite,
c. forming the second layer composite into a predetermined target shape,
wherein the upper layer is made of aluminium and wherein the aluminum layer has a thickness which corresponds to the thickness of the molded aluminum part.

20. Method according to claim 19, characterized in that the forming corresponds to a pressing process for molded aluminum parts.

21. Method according to claim 19, characterized in that the upper material layer is a wood veneer layer, a leather layer, a carbon layer, a textile layer, a fabric layer or a film layer.
